(19) United States
(12) Patent Application Publication
(10) Pub. No.: US 2006/0208639 A1
(43) Pub. Date: Sep. 21, 2006

(54) Plasma display panel

(76) Inventors: Hun-Suk Yoo, Suwon-si (KR); Won-Ju Yi, Suwon-si (KR)

Correspondence Address: CHRISTIE, PARKER & HALE, LLP, PO BOX 7068, PASADENA, CA, 91109-7068, US

(21) Appl. No.: 11/363,786

(22) Filed: Feb. 27, 2006

(30) Foreign Application Priority Data
Mar. 18, 2005 (KR) 10-2005-0022628

(51) Int. Cl. H01J 17/49

(52) U.S. Cl. 313/585; 313/582

(57) ABSTRACT

A PDP with an increased aspect ratio and transmittance and that is capable of having barrier ribs securely engaged to substrates is provided. The PDP includes front and rear substrates arranged to face each other. Barrier ribs partition a plurality of discharge cells between the front substrate and the rear substrate. Engagement protrusions are formed on facing surfaces of the barrier ribs along edges of the front and rear substrates. The facing surfaces face the edges of the front and rear substrates. Engagement grooves are formed on facing surfaces of the front and rear substrates which face the barrier ribs. First and second electrodes are formed to extend in a first direction. Address electrodes are formed to extend in a second direction crossing the first and second electrodes. Phosphor layers are formed in each of the discharge cells. The engagement grooves are formed to correspond to the engagement protrusions. The first and second electrodes are formed inside the barrier ribs in a shape surrounding each of the plurality of discharge cells, and are arranged sequentially in a direction substantially perpendicular to the front and rear substrates. The address electrodes are formed inside the barrier ribs in a shape surrounding each of the plurality of discharge cells.

### CROSS-REFERENCE TO RELATED APPLICATION

This application claims priority to and the benefit of Korean Patent Application No. 10-2005-0022628 filed in the Korean Intellectual Property Office on Mar. 18, 2005, the entire content of which is incorporated herein by reference.

### BACKGROUND OF THE INVENTION

(a) Field of the Invention

The present invention relates to a plasma display panel, and more particularly to a plasma display panel with an improved structure of electrodes.

(b) Description of the Related Art

In recent years, an apparatus using a plasma display panel (hereinafter, referred to as “PDP’) has been highlighted as a next generation large-sized flat display. Such a PDP has the excellent characteristics of a large screen, high definition, ultra-thinness, light weight, and wide viewing angle. Further, the PDP is simply manufactured and is easier to produce as a large screen in comparison to other flat types of displays.

The PDP may be classified as a direct current (DC) type, an alternating current (AC) type, and a hybrid type of PDP depending on an applied discharge voltage, and may be further classified as an opposing discharge type and a surface discharge type of PDP depending on a discharge configuration.

In the DC PDP, all electrodes are exposed to a discharge space, and electric charges move directly between corresponding electrodes. In the AC PDP, at least one electrode is surrounded with a dielectric layer, and electric charges do not move directly between corresponding electrodes but rather the discharge is performed using wall charges.

In the DC PDP, the charges move directly between the corresponding electrodes, and accordingly there is a problem in that the electrodes can be significantly damaged. In order to solve the aforementioned problem, an alternating current type of PDP having a three-electrode surface discharge structure has been recently adopted.

Referring to FIG. 1, a conventional surface discharge PDP, including the three-electrode surface discharge AC PDP, has a front substrate 200 and a rear substrate 300, and has a construction in which electrodes are buried within a dielectric material.

On the rear substrate 300, address electrodes 330, a rear-substrate dielectric layer 350, barrier ribs 390, and phosphor layers 370 are formed. Address electrodes 330 together with scan electrodes generate an address discharge. The rear-substrate dielectric layer 350 is formed to cover the address electrodes 330 on the rear substrate 300. The barrier ribs 390 define a plurality of discharge cells, and the phosphor layers 370 are formed both on side walls of the barrier ribs 390 and on the rear substrate 300 in which the barrier ribs 390 are not formed.

The front substrate 200 is disposed to be spaced apart from and to face the rear substrate 300. On the front substrate 200, pairs of electrodes 220, 230 generate a sustain discharge, the front-substrate dielectric layer 250 covering the pairs of electrodes 220, 230, and a protective film 290 are formed.

As stated, in the conventional PDP the pairs of electrodes are formed on the front substrate 200. In addition, visible light generated from the phosphor layer 370 transmits through the front substrate 200. Accordingly, in order to not block the visible light emitting from the discharge cells, the pairs of electrodes formed on the front substrate 200 are made of a transparent material. However, there is a disadvantage in that a discharge firing voltage has to be increased due to a high resistance of the transparent electrodes. Accordingly, opaque metal electrodes are used in order to reduce the resistance of the transparent electrodes. But the metal electrodes have a disadvantage in that the aspect ratio decreases because the opaque metal electrodes cannot transmit visible light.

Moreover, the electrodes are protected by the dielectric layer and the protective film, respectively, and thereby the transmittance of the visible light is significantly reduced.

In addition, in the conventional three-electrode surface discharge type of PDP, the electrodes generating the discharge are formed on top sides in the discharge spaces, that is, on an inner surface of the front substrate 200 through which the visible light is transmitted. Since the discharge generates around the inner surface of the front substrate and is spread out from the center of the discharge spaces, there is the disadvantage of low luminescence efficiency.

Further, in the conventional three-electrode surface discharge type of PDP, there is a further disadvantage in that image burning occurs when the PDP is used for long periods of time. In other words, charged particles of discharge gas move to the phosphor layers covering the address electrodes by an electric field, and generate an ion sputtering problem on the phosphor layers. Therefore, the phosphor layers deteriorate and the image burning problem occurs.

### SUMMARY OF THE INVENTION

The exemplary embodiments of the present invention provide a PDP wherein an aspect ratio and transmittance is increased by improving the structure of electrodes.

Further, the exemplary embodiments of the present invention provide a PDP in which barrier ribs can be securely engaged to the substrates by improving the engagement structure of the barrier ribs.

According to an exemplary embodiment of the present invention, a PDP includes front and rear substrates arranged to face each other. Barrier ribs partition a plurality of discharge cells between the front substrate and the rear substrate. At least one of the front and rear substrates have an engagement groove formed along an edge of a barrier rib facing surface thereof. An engagement protrusion is formed on a front substrate facing surface or a rear substrate facing surface of the barrier ribs along a surface edge of the front substrate or the rear substrate, the facing surface of the barrier ribs facing the periphery of the front and rear substrates. The engagement protrusion is coupled to the engagement grove of the front substrate or the rear substrate. First and second electrodes are formed to extend in a first direction. Address electrodes are formed to extend in a second direction crossing the first direction. Phosphor layers are formed in each of the discharge cells.

The first and second electrodes are formed inside the barrier ribs in a shape surrounding each of the plurality of discharge cells, and are arranged sequentially in a direction substantially perpendicular to the front and rear substrates.

The address electrodes are formed inside the barrier ribs in a shape surrounding each of the plurality of discharge cells.

The engagement protrusion may be formed along the surface edge in the shape of a closed loop. In addition, the engagement protrusion may be formed to protrude from the barrier ribs.

The engagement protrusion may be fitted into a corresponding engagement groove, and an engagement material may be further included between the engagement protrusions and the engagement groove. The engagement material may be a melted glass, such as frit.

The PDP may be divided into a display area for displaying an image and a non-display area not displaying the image, and the engagement protrusion and the engagement groove may be formed in the non-display area.

Concave surfaces may be formed on the front substrate corresponding to a position of each of the plurality of discharge cells, and the phosphor layers are formed by applying phosphors to the concave surfaces.

The discharge cells to be turned on are selected by the interaction between the first electrodes and the address electrodes, and a sustain discharge occurs in the selected discharge cells by the interaction between the first electrodes and the second electrodes.

The first, second, and address electrodes are sequentially arranged in order of the second, first, and address electrodes from the front substrate toward the rear substrate.

The barrier ribs include horizontal barrier ribs extending in the first direction and vertical barrier ribs extending in the second direction. The first electrodes include first line electrodes extending in the first direction and being buried within the horizontal barrier ribs, and first connection electrodes connecting the first line electrodes and being buried within the vertical barrier ribs. The second electrodes include second line electrodes extending in the first direction and being buried within the horizontal barrier ribs, and second connection electrodes connecting the second line electrodes and being buried within the vertical barrier ribs.

The first and second line electrodes may be arranged in pairs at boundaries between adjacent discharge cells in the second direction, respectively.

The address electrodes include third line electrodes extending in the second direction and being buried within the vertical barrier ribs, and third connection electrodes connecting the third line electrodes and being buried within the horizontal barrier ribs.

The third line electrodes are arranged in pairs at boundaries between adjacent discharge cells in the first direction.

The barrier ribs may be made of a dielectric material.

### BRIEF DESCRIPTION OF THE DRAWINGS

FIG. 1 is a partial exploded perspective view showing a conventional three-electrode surface discharge type of PDP.

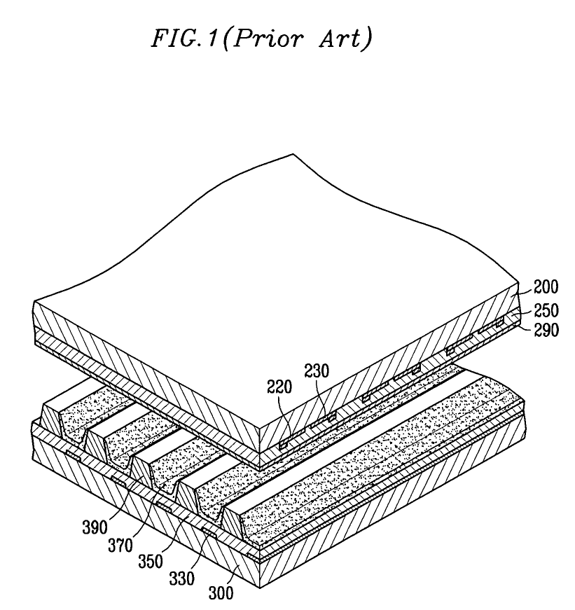

FIG. 2 is a partial exploded perspective view showing a PDP according to an exemplary embodiment of the present invention.

FIG. 3 is partial perspective view schematically illustrating the structure of electrodes in the PDP according to an exemplary embodiment of the present invention.

FIG. 4 is partial plan view schematically illustrating the arrangement relationship of barrier ribs and sustain electrodes in the PDP according to an exemplary embodiment of the present invention.

FIG. 5 is partial plan view schematically illustrating the arrangement relationship of barrier ribs and scan electrodes in the PDP according to an exemplary embodiment of the present invention.

FIG. 6 is partial plan view schematically illustrating the arrangement relationship of barrier ribs and address electrodes in the PDP according to an exemplary embodiment of the present invention.

FIG. 7 is a partial cross-sectional view taken along the line VII-VII of a non-exploded perspective view of the PDP of FIG. 2.

FIG. 8 is a partial cross-sectional view taken along the line VIII-VIII of a non-exploded perspective view of the PDP of FIG. 2.

### DETAILED DESCRIPTION

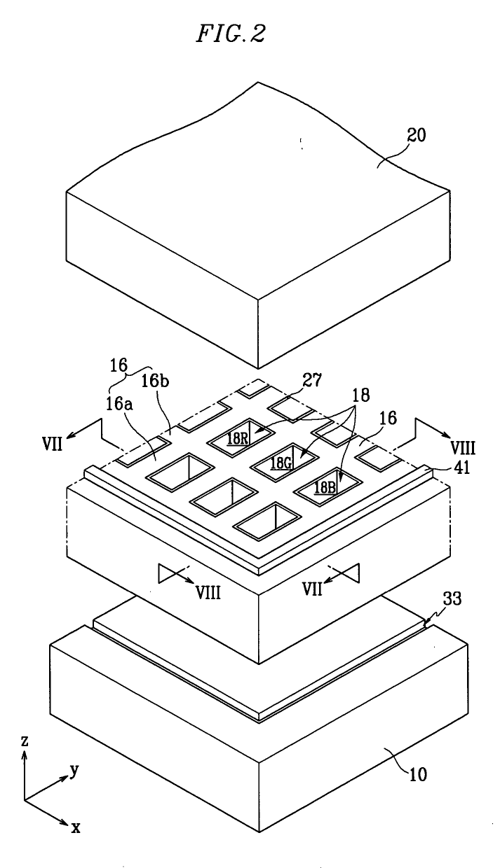

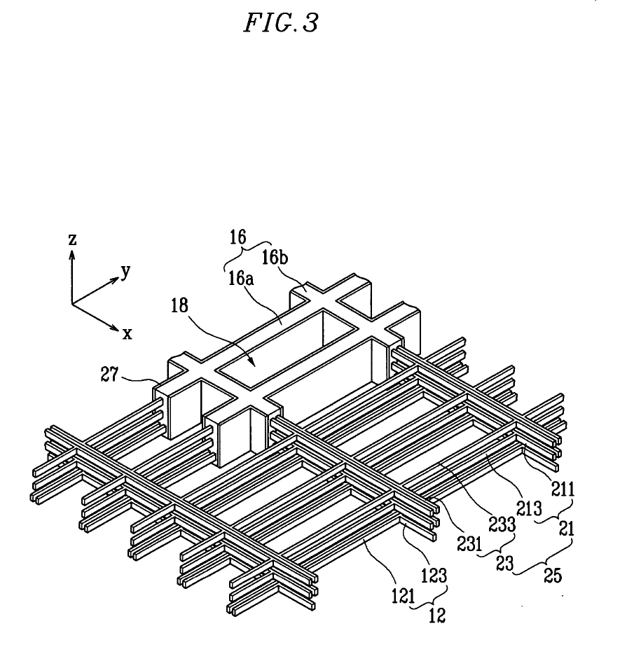

Referring first to FIGS. 2 and 3, the PDP of an exemplary embodiment of the present invention includes a rear substrate 10 and a front substrate 20 facing each other. Barrier ribs 16 partitioning discharge cells 18, which include red discharge cell 18R, green discharge cell 18G, and blue discharge cell 18B, are disposed between the rear and front substrates 10, 20. Display electrodes 25 and address electrodes 12 are buried within the barrier ribs 16, and the display electrodes 25 and the address electrodes 12 are formed to surround the discharge cells 18.

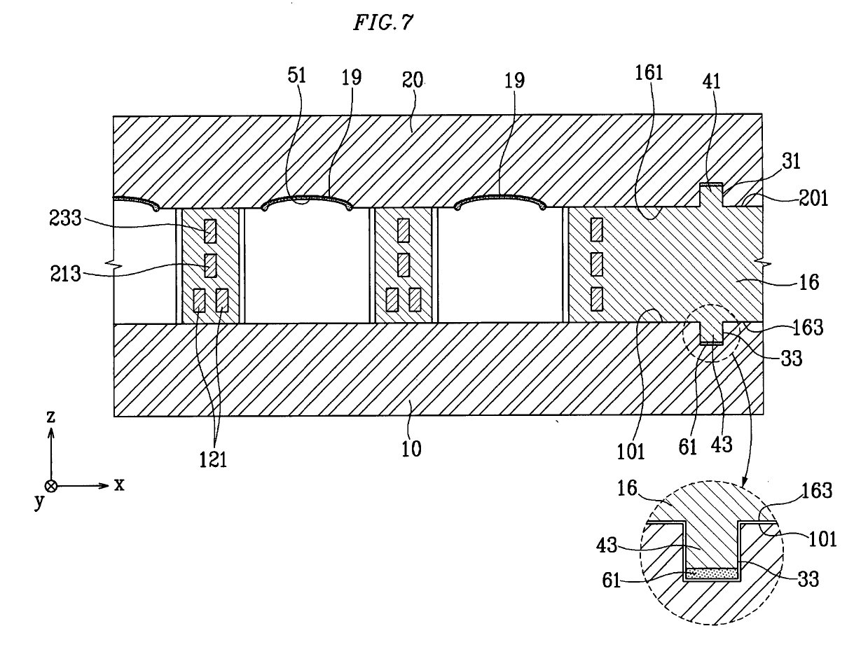

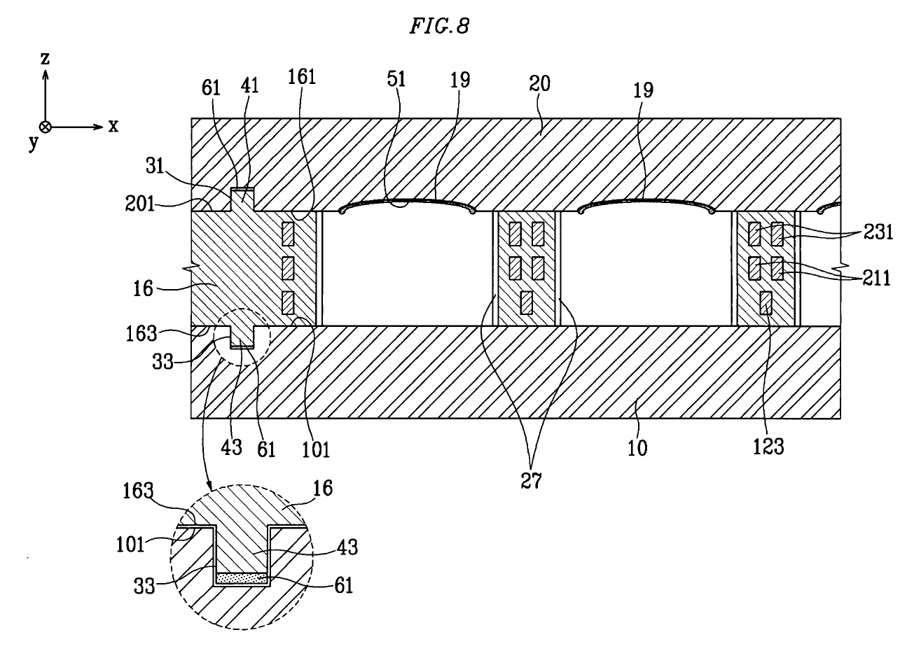

The front substrate 20 is a transparent glass substrate which is capable of transmitting visible light, and is disposed substantially parallel with the rear substrate 10. On opposing surfaces of the front and rear substrates 20, 10 engagement grooves 31, 33 are formed along the edges of the front and rear substrates 20, 10 respectively. Engagement protrusions 41, 43 protruding from the barrier ribs 16 are engaged into the engagement grooves 31, 33 respectively, briefly referring to FIGS. 7 and 8. A detailed description thereof will be given below.

Phosphor layers 19 are further formed in the front substrate 20, again briefly referring to FIGS. 7 and 8. The phosphor layers 19 will be explained below together with the structures of the discharge cells that will also described below.

In an exemplary embodiment of the present invention, the display electrodes 25 and the address electrodes 12 are formed inside the barrier ribs 16, surrounding the discharge cells 18. The display electrodes 25 include first electrodes 21 (hereinafter, referred to as “scan electrodes”) and second electrodes 23 (hereinafter, referred to as “sustain electrodes”). The scan electrodes 21 interact with the address electrodes 12, thereby selecting the discharge cells to be turned on. The sustain electrodes 23 interact with the scan electrodes 21, thereby causing a discharge in the selected discharge cells.

In an exemplary embodiment, the display electrodes 25 and the address electrodes 12 may be arranged in the order of the sustain, the scan, and the address electrodes 23, 21, 12 from the front substrate 20 toward the rear substrate 10.

The distance between the scan electrodes 21 and the address electrodes 12 with this arrangement is shorter than the distance between the scan and address electrodes in the structure of the conventional three-electrode surface discharge type of PDP. Accordingly, the addressing performance that selects the discharge cells to be turned on can be made with a lower voltage. In addition, the scan and sustain electrodes 21, 23 that generate the sustain discharge are arranged close to the front substrate 20, and thereby the phosphor layers formed on the front substrate 20 can be provided close to the scan and sustain electrodes 21, 23.

The barrier ribs 16 burying the display and address electrodes 25, 12 may be made of dielectric materials such as PbO, B₂O₆, and SiO₂. Therefore, the barrier ribs 16 electrically insulate the scan, sustain, and address electrodes 21, 23, 12 that are arranged therein together, as well as partition the discharge cells 19 as independent discharge spaces.

The barrier ribs 16 prevent charged particles from colliding with the display and address electrodes 25, 12 directly, thereby reducing damage of the display and address electrodes 25, 12 caused by such collision. In addition, the barrier ribs 16 play a role in accumulating wall charges thereon by interaction with the charged particles.

The barrier ribs 16 in an exemplary embodiment are integrally formed. However, the barrier ribs 16 can be formed with a laminated structure in which multiple barrier ribs are layered. For example, in a case of the barrier ribs having 2 layers, it is preferable that the display electrodes 25 are buried within first barrier ribs arranged close to the front substrate 20, and that the address electrodes 12 are buried within second barrier ribs arranged close to the rear substrate 10.

Referring again to FIG. 2, the barrier ribs 16 have horizontal barrier ribs 16b extending in the first direction (x-axis direction in the drawing), and vertical barrier ribs 16a extending in the second direction (y-axis direction in the drawing) crossing the horizontal barrier ribs 16b. The discharge cells 18 are configured in a lattice shape by the horizontal and vertical barrier ribs 16b, 16a. However, the present invention is not limited to such an exemplary embodiment, and discharge cells having various shapes can be applied to the present invention. In addition, the planar shape of each of the discharge cells 18 may be a circle.

Protective films 27 may be formed on side walls of the barrier ribs 16 partitioning the discharge cells 18. The protective films 27 prevent the charged particles from colliding with the barrier ribs 16 and damaging them. Further, the protective films 27 emit secondary electrons during the discharge.

As previously stated, the display and address electrodes 25, 12 buried within the barrier ribs 16 surround the discharge cells 18. In the present exemplary embodiment, the display electrodes 25 are sequentially arranged in the order of the sustain electrodes 23 and the scan electrodes 21 from the front substrate 20 toward the rear substrate 10. Moreover, the sustain and scan electrodes 23, 21 extend in the first direction (x-axis direction in the drawings). The address electrodes 12 are formed below the sustain and scan electrodes 23, 21 along the second direction (y-axis direction in the drawings) crossing the first direction (x-axis direction in the drawings). In addition, the address electrodes 12 are formed to surround the discharge cells 18, while being buried within the barrier ribs 16.

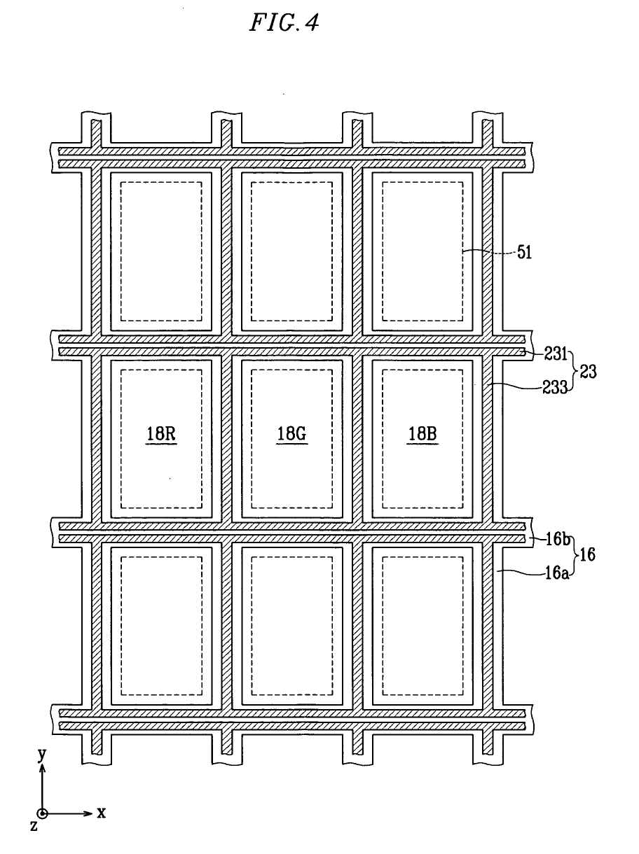

FIG. 4 is a partial plan view schematically illustrating the arrangement relationship of the barrier ribs and the sustain electrodes. The sustain electrodes 23 include first line electrodes 231 and first connection electrodes 233. The first line electrodes 231 are buried within the horizontal barrier ribs 16b, and the first connection electrodes 233 are buried within the vertical barrier ribs 16a formed in the direction crossing the horizontal barrier ribs 16b.

That is to say, the first line electrodes 231 are formed inside the horizontal barrier ribs 16b formed along the first direction (x-axis direction in the drawing), and extend in the first direction (x-axis direction in the drawing).

The first line electrodes 231 are formed in pairs inside the horizontal barrier ribs 16b. In other words, the first line electrodes 231 are arranged in pairs at the boundaries between the adjacent discharge cells 18 in the second direction (y-axis direction in the drawing). Accordingly, the first line electrodes 231 are respectively provided on both sides of one discharge cell 18 in the second direction (y-axis direction in the drawing).

The first connection electrodes 233 are formed inside the vertical barrier ribs 16a formed along the second direction (y-axis direction in the drawing). The first connection electrodes 233 connect the first line electrodes 231 provided on both sides of one discharge cell 18 in the second direction (y-axis direction in the drawing). In other words, with respect to one row of discharge cells 18, the first line electrodes 231 are respectively arranged in a row direction with the one row of discharge cells 18 therebetween, and the first connection electrodes 233 are arranged in the column direction. Therefore, the sustain electrodes 23 having the first line electrodes 231, the first connection electrodes 233 are formed in a ladder shape substantially surrounding the discharge cells 18, and substantially extending in the first direction (x-axis direction in the drawing).

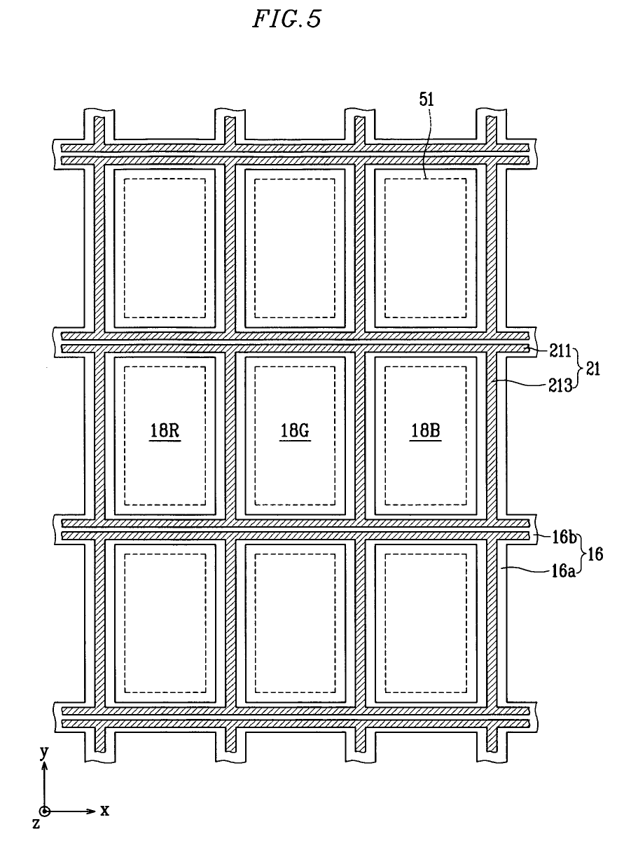

FIG. 5 is a partial plan view schematically illustrating the arrangement relationship of the barrier ribs and the scan electrodes. In the present exemplary embodiment, the sustain electrodes 23 buried within the barrier ribs 16 are disposed close to the front substrate 20, and the scan electrodes 21 buried within the barrier ribs 16 are spaced apart from the sustain electrodes 23 in the direction substantially perpendicular to the front substrate 20. Here, the scan electrodes 21 and the sustain electrodes 23 are formed with substantially the same shape.

Referring still to FIG. 5, the scan electrodes 21 include second line electrodes 211 and second connection electrodes 213. The second line electrodes 211 are buried within the horizontal barrier ribs 16b, and the second connection electrodes 213 are buried within the vertical barrier ribs 16a formed in the direction crossing the horizontal barrier ribs 16b.

As such, since the sustain and scan electrodes 23, 21 are sequentially arranged in the z-axis direction inside the barrier ribs 16. The sustain and scan electrodes 23, 21 are formed to surround the circumference of the discharge cells and to face each other in the z-axis direction. Meanwhile, the address electrodes 12 are further formed below the sustain and scan electrodes 23, 21, as described above.

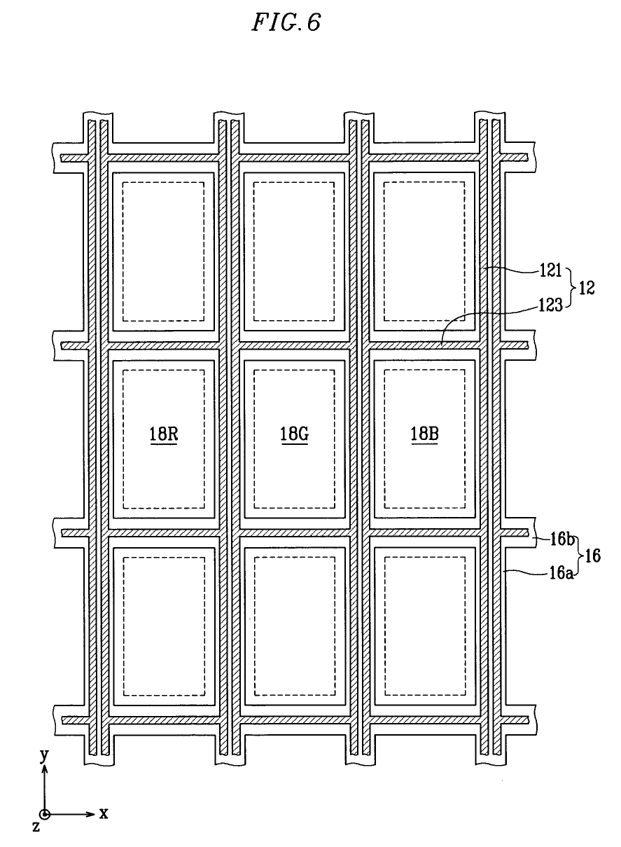

FIG. 6 is a partial plan view schematically illustrating the arrangement relationship of the barrier ribs and the address electrodes. The address electrodes 12 are formed to extend in the second direction (y-axis direction in the drawing) substantially crossing the display electrodes 25.

The address electrodes 12 include third line electrodes 121 and third connection electrodes 123. The third line electrodes 121 are buried within the vertical barrier ribs 16b and extend in the second direction (y-axis direction in the drawing). The third connection electrodes 123 are buried within the horizontal barrier ribs 16b and connect the third line electrodes 121. That is to say, the third line electrodes 121 are formed inside the vertical barrier ribs 16a formed along the second direction (y-axis direction in the drawing), and extend in the second direction (y-axis direction in the drawing).

The third line electrodes 121 are formed in pairs inside the vertical barrier ribs 16a. In other words, the third line electrodes 121 are arranged in pairs at the boundaries between adjacent discharge cells 18 in the first direction (x-axis direction in the drawing). Accordingly, the third line electrodes 121 are respectively provided on both sides of one discharge cell 18 in the first direction (x-axis direction in the drawing).

The third connection electrodes 123 are formed inside the horizontal barrier ribs 16a formed along the first direction (x-axis direction in the drawing). The third connection electrodes 123 connect the third line electrodes 121 provided on both sides of one discharge cell 18 in the first direction (x-axis direction in the drawing). In other words, with respect to one column of discharge cells 18, the third line electrodes 121 are respectively arranged in the column direction with one column of discharge cells 18 therebetween, and the third connection electrodes 123 are arranged in the row direction. Therefore, the address electrodes 12 having the third line electrodes 121 and the third connection electrodes 123 are formed in a ladder shape substantially surrounding the discharge cells 18, and substantially extend in the second direction (y-axis direction in the drawing) unlike the sustain and scan electrodes 23, 21. Accordingly, the address electrodes 12 are formed in the direction crossing the sustain and scan electrodes 23, 21.

FIG. 7 is a partial cross-sectional view taken along the line VII-VII of a non-exploded perspective view of the PDP of FIG. 2, and FIG. 8 is a partial cross-sectional view taken along the line VIII-VIII of a non-exploded perspective view of the PDP of FIG. 2.

FIG. 7 and FIG. 8 are cross-sectional views showing the edge portion of the PDP according to an exemplary embodiment of the present invention. As shown in the drawings, the barrier ribs 16 in the present exemplary embodiment are fitted into the front and rear substrates 20, 10, respectively.

As shown in FIG. 7 and FIG. 8, engagement protrusions 41, 43 are formed in the barrier ribs 16. Moreover, engagement grooves 31, 33 are formed on the front and rear substrates 20, 10, respectively. The engagement protrusions 41, 43 are configured to fit into the engagement grooves 31, 33.

The engagement protrusions 41, 43 are formed on the facing surfaces 161, 163 of the barrier ribs 16, which face the edge portion of the front and rear substrates 20, 10, respectively. The engagement protrusions 41, 43 are formed to protrude from the facing surfaces 161, 163. In an exemplary embodiment the engagement protrusions 41, 43 are formed in a shape of a closed loop along the edge portion. Moreover, the PDP is substantially divided into a display area for displaying an image and a non-display area not displaying an image, and the engagement protrusions 41, 43 are preferably formed in the non-display area.

The engagement grooves 31, 33 corresponding to the engagement protrusions 41, 43 in shape are formed on the front and rear substrates 20, 10, respectively.

More specifically, the barrier ribs are disposed between the front substrate 20 and the rear substrate 10, and the engagement grooves 31, 33 are formed on the facing surfaces 201, 101 of the front and rear substrates 20, 10, which face the barrier ribs 16. The engagement grooves 31, 33 are formed to hollow out on the facing surfaces 201, 101. In addition, the engagement grooves 31, 33 are formed in a shape of a closed loop along the edge portion of the front and rear substrates 20, 10. In this case, the engagement grooves 31, 33 are formed in positions corresponding to the engagement protrusions 41, 43, and thereby the engagement protrusions 41, 43 fit into the engagement grooves 31, 33 at the right positions.

In the present exemplary embodiment, an engagement material 61 may be further provided between the engagement protrusions 41, 43 and the engagement grooves 31, 33, respectively. When the engagement protrusions 41, 43 are fitted into the engagement grooves 31, 33, respectively, the engagement material 61 fills a gap therebetween and enhances the capability of the engagement therebetween. A melted glass such as frit may be used as the engagement material 61, and thereby it is not necessary to seal the front and rear substrates with the use of the sealing material as in the prior art.

Hereinafter, the phosphor layers 19 in the discharge cells according to the present exemplary embodiment are described.

In the present exemplary embodiment, the phosphor layers 19 are provided on the front substrate 20. Since the visible light for displaying an image has to be emitted through the front substrate 20, phosphors having a characteristic of transmitting visible light are used in the present exemplary embodiment.

A plurality of concave surfaces 51 are provided on the facing surface 201 of the front substrate 20, which faces the rear substrate 10. As shown in FIGS. 4 to 8, the plurality of concave surfaces 51 are formed on the front substrate 20 in positions corresponding to the positions of the discharge cells 18, respectively.

The phosphor layers 19 are formed on the plurality of concave surfaces 51. and can be formed using any one of red, green, and blue phosphors to represent color. Accordingly, the phosphor layers 19 may be classified into red, green, and blue phosphor layers 18R, 18G,18B. As described above, a discharge gas, such as a mixture of neon (Ne) and xenon (Xe), is filled into the discharge cells 18 where the phosphor layers 19 are formed.

In the PDP according to the present exemplary embodiment, the sustain and scan electrodes 23, 21 are not disposed on the front substrate 20 through which the visible light is transmitted, but are disposed on the sides of discharge spaces. Accordingly, metal electrodes having low resistance may be used as the sustain and scan electrodes, instead of transparent electrodes having high resistance. When the metal electrodes are used, a response time to discharge is shortened and driving of the PDP with a low voltage is possible without distortion of waves.

Hereinafter, an exemplary driving method with the use of the memory characteristics of wall charges in the PDP according to the present exemplary embodiments is described.

In the case that an address voltage is applied between the address electrodes 12 and the scan electrodes 21, the discharge cells 18 where discharges occur are selected. The wall charges are accumulated on the dielectric layers formed on the address and scan electrodes 12, 21 in the selected discharge cells 18.

Subsequently, a positive voltage is applied to the scan electrodes 21 and the voltage lower than the positive voltage is applied to the sustain electrodes 23, and thereby a sustain discharge occurs between the scan and sustain electrodes 21, 23. In other words, by the voltage difference between the scan electrodes 21 and the sustain electrodes 23, the accumulated wall charges move to opposite directions in accordance with their polarities. Next, the wall charges collide with the discharge gas in the discharge cells 18 while moving in the discharge spaces, and thereby plasma is generated. A relatively strong electric field is formed in the region in the vicinity of the sustain and scan electrodes 23, 21. Accordingly, there is a high possibility that the discharge is generated from the region in the vicinity of the sustain and scan electrodes 23, 21.

In the present exemplary embodiment, the sustain and scan electrodes 23, 21 are disposed to face each other along the edges of the discharge cells 18. Thus, there is a strong possibility of the discharge being generated, compared with the prior art in which the display electrodes are disposed only on the top side of the discharge cells.

When the voltage difference between the two electrodes 21, 23 is maintained during the predetermined time, the discharge is gradually spread out in the discharge cells 18.

The discharge in accordance with the present exemplary embodiments is generated as a ring shape from the four sides of each of the discharge cells 18, and is spread toward the center of each of the discharge cells 18. On the other hand, the discharge in the three-electrode surface discharge type of PDP is generated from the top side of each of the discharge cells, and is spread toward the center of each of the discharge cells. As such, the discharge regions in the present exemplary embodiment are different from those in the prior art. Accordingly, compared with the prior three-electrode surface-discharge structure, the diffusion extent of the discharge in the present exemplary embodiment is significantly improved. Moreover, since the volume of the region in which discharge occurs drastically increases, the amount of visible light is significantly enhanced. In addition, since the plasma concentrates at the center of each of the discharge cells 18, space charges can be utilized. By utilizing the space charges, it is possible to drive the PDP with a low voltage and luminescence efficiency can be enhanced.

In addition, since the electric field generated by the sustain and scan electrodes is formed in the region of the sides in the discharge cells and the phosphor layers are formed on the front substrate, charged particles generated by the discharge are prevented from colliding with phosphor layers. Therefore, the ion sputtering phenomenon generated from collision between the charged particles and the phosphor layers can be prevented. According to exemplary embodiments of the present invention, other elements, except the substrate itself, are not needed on the front substrate through which the visible light displaying the image transmits. Therefore, the aspect ratio and transmittance can be significantly increased.

Since the discharges are generated from the sides in the discharge spaces and spread into the centers of the discharge cells, the regions where discharge occurs can be uniformly expanded. In addition, the amount of plasma is increased, thereby enhancing the luminescence efficiency greatly. Since the plasma can be concentrated at the center of the discharge spaces, the luminescence efficiency can be further enhanced.

In the PDP in accordance with exemplary embodiments of the present invention, the electrodes are buried within the barrier ribs and the distance between the electrodes is small. Accordingly, it is possible to greatly lower a discharge firing voltage and drive the PDP with a low voltage, thereby increasing discharge efficiency.

In a case that high Xe gas is used as the discharge gas so as to increase the luminescence efficiency, it is generally difficult to drive the PDP with a low voltage. However, according to the present exemplary embodiment, the discharge firing voltage can be further lowered. Accordingly, it is possible to drive the PDP with a low voltage in the case that high Xe gas is used as the discharge gas, and thereby the luminescence efficiency can be enhanced.

Moreover, in the PDP in accordance with exemplary embodiments of the present invention, image burning can be prevented. In other words, even if discharge occurs over a long time and ions generated by the discharge are moved by the electric filed, the ions are prevented from colliding with the phosphor layers. Therefore, damage of the phosphor layers by the ion sputtering is prevented, and thereby the problem of image burning occurring from the damage of the phosphor layers can be solved. In particular, the problem of image burning is very serious when high Xe gas is used as the discharge gas. The exemplary embodiments according to the present invention can help prevent this problem.

Since the engagement protrusions and engagement grooves are provided in the PDP according to the present invention, the barrier ribs can be securely fixed to the front and rear substrates. Therefore, distortion of the barrier ribs during manufacturing the PDP and from external impact can be prevented.

While the present invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A plasma display panel, comprising:
a front substrate and a rear substrate arranged to face each other, at least one of the front substrate and rear substrate having an engagement groove formed along a surface edge facing the other substrate of the front substrate and rear substrate;
barrier ribs partitioning a plurality of discharge cells between the front substrate and the rear substrate, at least one barrier rib having a front substrate facing surface and a rear substrate facing surface, the at least one barrier rib having an engagement protrusion protruding from the front substrate facing surface or the rear substrate facing surface, the engagement protrusion being coupled to a corresponding engagement groove;
first electrodes and second electrodes formed to extend in a first direction and formed inside the barrier ribs in a shape surrounding each of the plurality of discharge cells, and arranged sequentially in a direction substantially perpendicular to the front substrate and the rear substrate;
address electrodes formed to extend in a second direction crossing the first direction, and formed inside the barrier ribs in a shape surrounding each of the plurality of discharge cells; and
phosphor layers formed in each of the discharge cells.

2. The plasma display panel of claim 1, wherein the engagement protrusion extends along the surface edge in a closed loop.

3. The plasma display panel of claim 1, wherein the engagement protrusion is formed to protrude from both the front substrate facing surface and the rear substrate facing surface of the at least one barrier rib.

4. The plasma display panel of claim 1, wherein the engagement protrusion is fitted into the engagement groove, and wherein an engagement material is further included between the engagement protrusion and the engagement groove.

5. The plasma display panel of claim 4, wherein the engagement material is melted glass.

6. The plasma display panel of claim 1, wherein:
the plasma display panel is divided into a display area for displaying an image and a non-display area not displaying the image, and
the engagement protrusion and the engagement groove are formed in the non-display area.

7. The plasma display panel of claim 1, wherein:
concave surfaces are formed on the front substrate corresponding to a position of each of the plurality of discharge cells, and
the phosphor layers include phosphors applied to the concave surfaces.

8. The plasma display panel of claim 1, wherein:
discharge cells to be turned on are selected by an interaction between the first electrodes and the address electrodes, and
a sustain discharge occurs in selected discharge cells by an interaction between respective first electrodes and second electrodes.

9. The plasma display panel of claim 8, wherein the first electrodes, the second electrodes, and the address electrodes are sequentially arranged in order of the second electrodes, the first electrodes, and the address electrodes, ranging from the front substrate toward the rear substrate.

10. The plasma display panel of claim 1, wherein:
the barrier ribs further comprise horizontal barrier ribs extending in the first direction and vertical barrier ribs extending in the second direction,
the first electrodes further comprise first line electrodes extending in the first direction and being buried within the horizontal barrier ribs, and first connection electrodes connecting the first line electrodes and being buried within the vertical barrier ribs, and
the second electrodes further comprise second line electrodes extending in the first direction and being buried within the horizontal barrier ribs, and second connection electrodes connecting the second line electrodes and being buried within the vertical barrier ribs.

11. The plasma display panel of claim 10, wherein the first line electrodes and the second line electrodes are arranged in pairs at boundaries between adjacent discharge cells in the second direction.

12. The plasma display panel of claim 10, wherein the address electrodes further comprise third line electrodes extending in the second direction and being buried within the vertical barrier ribs, and third connection electrodes connecting the third line electrodes and being buried within the horizontal barrier ribs.

13. The plasma display panel of claim 12, wherein the third line electrodes are arranged in pairs at boundaries between adjacent discharge cells in the first direction.

14. The plasma display panel of claim 1, wherein the barrier ribs are dielectric material.
